(19) United States
(12) Patent Application Publication
(10) Pub. No.: US 2010/0169930 A1
(43) Pub. Date: Jul. 1, 2010

(54) BROADCASTING RECEIVER AND METHOD OF SEARCHING FOR KEYWORD OF BROADCASTING RECEIVER

(75) Inventors: Minoru ITO, Yokohama (JP); Noriya MASHIMO, Yokohama (JP)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si, (KR)

(21) Appl. No.: 12/644,429

(22) Filed: Dec. 22, 2009

(30) Foreign Application Priority Data
Dec. 25, 2008 (JP) 2008-330510
Sep. 25, 2009 (KR) 10-2009-0091153

(51) Int. Cl. H04N 5/445; G06F 17/00

(52) U.S. Cl. 725/53; 707/706; 707/E17.014

(57) ABSTRACT

A method of searching a keyword includes extracting a keyword from subtitle data included in a broadcast signal, displaying an extracted keyword with an image according to the broadcast signal, searching for a keyword using an search engine through a communication network when an instruction to search a displayed keyword is received, and displaying a search result by the search engine.

### CROSS-REFERENCE TO RELATED PATENT APPLICATIONS

This application claims the benefits of Korean Patent Application No. 10-2009-0091153, filed on Sep. 25, 2009, in the Korean Intellectual Property Office, and Japanese Patent Application No. 2008-330510, filed on Dec. 25, 2008, in the Japanese Patent Office, the disclosures of which are incorporated herein in their entirety by reference.

### BACKGROUND

1. Field

The exemplary embodiments relate to a broadcasting receiver and a method of searching for a keyword of a broadcasting receiver.

2. Description of the Related Art

Conventionally, technology to provide free text searching of electronic program guide (EPG) data in a digital television system has been disclosed, for example, in Japanese Patent Laid-Open Publication No. 2004-289848.

However, when watching a program broadcasted via a digital television, viewers often wish to collect more information about the program. Since the conventional technology enables merely text searching of the EPG guide, a text related to the program the viewer is watching is not searched. Thus, even when the viewer acquires more information during watching a program, it is impossible to collect necessary information.

### SUMMARY

To solve the above and/or other problems, the exemplary embodiments provide a broadcasting receiver which enables a viewer of a program to acquire information related to the program from a search engine during watching the program, and a method of searching for a keyword.

According to an aspect, a method of searching a keyword includes extracting a keyword from subtitle data included in a broadcast signal, displaying an extracted keyword with an image according to the broadcast signal, searching for a keyword using an search engine through a communication network when an instruction to search a displayed keyword is received, and displaying a search result by the search engine.

According to the above method, a keyword is extracted from subtitle data included in a broadcast signal and an extracted keyword is displayed with an image according to the broadcast signal. When an instruction to search a displayed keyword is received, the keyword is searched for using a search engine through a communication network and a search result is displayed by the search engine. Thus, information about the broadcasting may be further acquired by the search engine.

According to another aspect, a broadcasting receiver includes a signal processing unit acquiring subtitle data from a broadcast signal, a keyword extraction unit extracting a keyword from the subtitle data, a keyword display instruction unit displaying an extracted keyword with an image according to the broadcast signal, a search instruction unit searching a keyword by using a search engine through a communication network when a search instruction is received with respect to the displayed keyword, and a search result display unit displaying a search result by the search engine.

According to the above structure, subtitle data is acquired from a broadcast signal, a keyword is extracted from the subtitle data, an extracted keyword is displayed with an image according to the broadcast signal, a keyword is searched for by using a search engine through a communication network when a search instruction is received with respect to the displayed keyword, and a search result is displayed by the search engine. Thus, information about the broadcasting may be further acquired by the search engine.

The broadcasting receiver may further include an appearance frequency calculation unit calculating the frequency of appearance of a keyword extracted by the keyword extraction unit, wherein the keyword display instruction unit displays a plurality of keywords in order of the frequency of appearance. According to the above structure, a user may further search for a keyword with a high appearance frequency.

The keyword extraction unit may extract a keyword only when a program designated by a user is received.

According to another aspect, a broadcasting receiver includes a signal processing unit acquiring subtitle data from a broadcast signal, a central processing unit extracting a keyword from the subtitle data acquired by the signal processing unit, searching for the keyword by using a search engine through a communication network when a search instruction is received with respect to the extracted keyword, and displaying a search result, and a display control unit displaying a keyword extracted by the central processing unit and a result of the keyword search, on a display panel.

According to the above structure, while watching a program, a user may efficiently search for information related to the program in real time by using the search engine.

According to another aspect, there is a method of searching including: extracting a plurality of text from subtitle data of a broadcast signal; determining frequencies of appearance of the plurality of text; displaying the extracted plurality of text according to the determined frequencies of appearance; receiving user input regarding a user selection of one of the displayed plurality of text; transferring the selected one of the plurality of text to a search engine; receiving a search result from the search engine; and displaying the search result.

### BRIEF DESCRIPTION OF THE DRAWINGS

The above and other features and aspects will become more apparent by describing in detail exemplary embodiments thereof with reference to the attached drawings in which:

FIG. 1 is a block diagram showing the structure of a digital broadcasting receiver according to an exemplary embodiment;

FIG. 2 is a block diagram showing the functional structure of a CPU operating according to a program;

FIG. 3 is a block diagram showing the state of a display panel on which keywords with priorities are displayed based on the frequency of appearance; and

FIG. 4 is a flowchart for explaining the process of a digital broadcasting receiver.

### DETAILED DESCRIPTION

The attached drawings for illustrating exemplary embodiments are referred to in order to gain a sufficient understanding of the exemplary embodiments, the merits thereof, and the objectives accomplished by the implementation of the exemplary embodiment. Hereinafter, the exemplary embodiments will be described in detail with reference to the attached drawings. Like reference numerals in the drawings denote like elements.

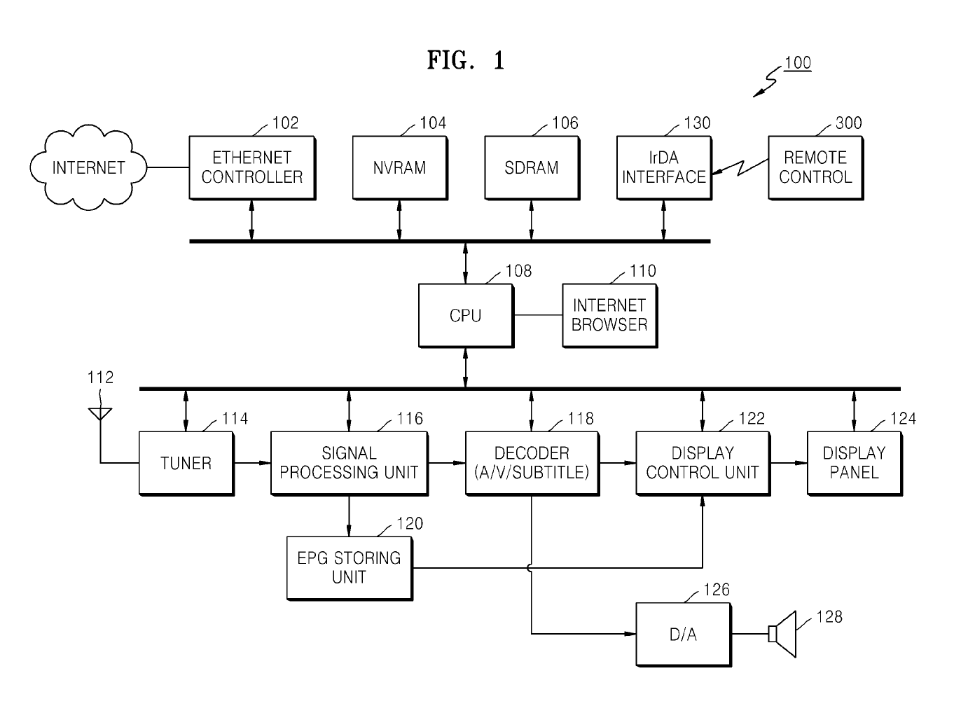

FIG. 1 is a block diagram showing the structure of a digital broadcasting receiver 100 according to an exemplary embodiment. The digital broadcasting receiver 100 according to the present exemplary embodiment is an apparatus to receive and watch a terrestrial digital broadcast signal. Also, the digital broadcasting receiver 100 may be connected to an Internet 150 and acquire various information through the Internet 150.

Referring to FIG. 1, the digital broadcasting receiver 100 includes an Ethernet controller 102 connected to a network such as the Internet, a nonvolatile random access memory (NVRAM) 104, a synchronous dynamic random access memory (SDRAM) 106, a central processing unit (CPU) 108, an Internet browser 110, an antenna 112, a tuner 114, a signal processing unit 116 for processing demultiplexing (DEMUX), a decoder 118, an electronic program guide (EPG) storing unit 120, a display control unit 122, a display panel 124, a digital-to-analog (D/A) converter 126, a speaker 128, an infrared data association (IrDA) interface 130, and a remote controller 300.

The digital broadcasting receiver 100 may be connected to the Internet 150 via the Ethernet controller 102. The various information acquired from the Internet 150 may be displayed on the display panel 124 by browsing a webpage using the Internet browser 110. The Internet browser 110 is application software to browse a webpage and functions the CPU 108 as a browser. The application soft (program) of the Internet browser 110 is stored in a memory in the digital broadcasting receiver 100. The NVRM 104 and the SDRAM 106 are memories to maintain the information acquired through the Internet 150 and software program. In particular, a user appointed program used to extract a keyword may be stored in the NVRM 104 and the SDRAM 106.

Also, the tuner 114 of the digital broadcasting receiver 100 receives a terrestrial digital broadcast signal via the antenna 112. The received broadcast signal is transmitted to the signal processing unit 116. The signal processing unit 116 separates a multiplexed signal by DEMUX processing and also separates transport stream received from the tuner 114 into elementary stream (ES) such as image (video) data, voice (audio) data, and subtitle data, and transmits the separated signal to the decoder 118. The decoded image data and the subtitle data are displayed on the display panel 124 under the control of the display control unit 122. Also, the decoded voice data is converted to an analog signal by the D/A converter 126 and then transmitted to the speaker 128.

The signal processing unit 116 performs service information/program specific information (IS/PSI) processing, separates EPG data from the broadcast signal, and transmits the EPG data to the EPG storing unit 120. The EPG data is displayed on the display panel 124 under the control of the display control unit 122.

In the digital broadcasting receiver 100 according to the present exemplary embodiment configured as above, the CPU 108 functioning according to the program stored in the memory extracts a keyword, for example, a noun, from the subtitle data and several keywords having a high frequency of appearance. The CPU 108 assigns priorities to the several extracted keywords based on the frequency of appearance and transmits the keywords and information about the frequency of appearance to the display control unit 122 to be displayed on the display panel 124.

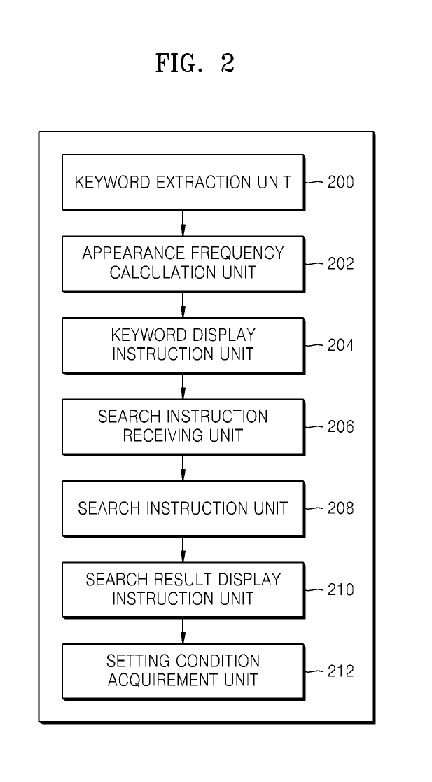

FIG. 2 is a block diagram showing the functional structure of the CPU 108 operating according to a program. Referring to FIG. 2, the functional structure of the CPU 108 includes a keyword extraction unit 200, an appearance frequency calculation unit 202, a keyword display instruction unit 204, a search instruction receiving unit 206, a search instruction unit 208, a search result display instruction unit 210, and a setting condition acquirement unit 212.

The keyword extraction unit 200 extracts from the decoded subtitle data a keyword that may become a search keyword. The appearance frequency calculation unit 202 calculates the frequency of appearance by counting the number of appearances within a predetermined time for each keyword extracted by the keyword extraction unit 200. The keyword display instruction unit 204 instructs the display control unit 122 to display the extracted keywords on the display panel 122 by assigning priorities to the extracted keywords in order of the high appearance frequency of the extracted keywords.

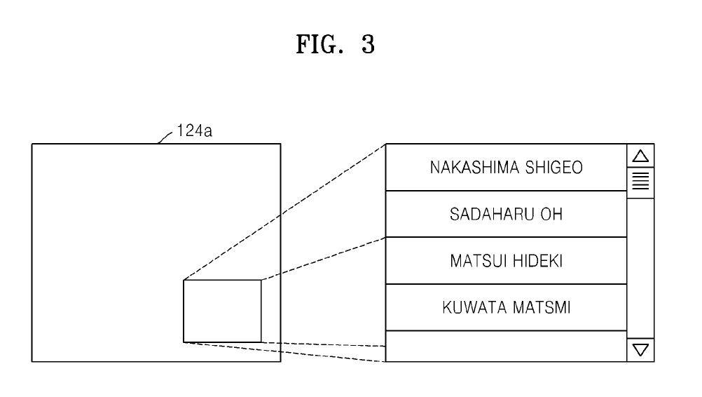

FIG. 3 is a block diagram showing the state of the display panel 124 on which keywords with priorities are displayed based on the frequency of appearance. FIG. 3 illustrates a case of watching, for example, a sports program. In this case, subtitle data includes relatively large number of the names of sports players. In the case of FIG. 3, the names of famous baseball players are extracted from the subtitle data. That is, “Nakashima Shigeo”, “Sadaharu Oh”, “Matsui Hideki”, and “Kuwata Matsmi” are extracted in order of the appearance frequency and displayed on a display screen 124a of the display panel 124.

The keywords illustrated in FIG. 3 are displayed with an image of a program in the display screen 124a. Thus, while watching a sport program, a user may recognize in real time a keyword with a high appearance frequency from the subtitle data.

When the user wishes to acquire more information about the displayed keyword, the user may select one of the keywords by using the remote controller 300 of FIG. 1 and transfers the selected keyword to a search engine (not shown) via the Internet 150. When a keyword is selected by using the remote controller 300, the information thereon is transferred to the CPU 108 through the IrDA interface 130. The search instruction receiving unit 206 of FIG. 2 receives the search instruction according to the selected keyword. The search instruction unit 208 instructs for transferring the selected keyword to a server of the search engine through the Ethernet controller 102 and the Internet 150. As a result of search, the information transferred by the server of the search engine is displayed on the display panel 124 according to the instruction by the search result display instruction unit 210.

As the CPU 108 transfers the selected keyword to the search engine via the Internet 150, the search engine to which the keyword is input conducts keyword search. Information about the list of home pages visited is transferred to the digital broadcasting receiver 100 to be displayed on the display panel 124. The information may be browsed on the display screen 124a of the display panel 124 owing to the function of the Internet browser 110. As a result, while watching a program, the user may acquire detailed information about the program.

Thus, according to the digital broadcasting receiver 100 of the present exemplary embodiment, detailed information about a program may be acquired in real time because a broadcasting receiving function such as a terrestrial digital wave and a search function through the Internet 150 may be combined with each other.

There is no need to extract keywords from programs of all genres. Whether to extract keywords may be appropriately determined according to user settings. In other words, keywords may be extracted from only a program in a genre previously designated by a user. For example, in FIG. 3, when extracting keywords from only a sports program is previously set by a user, the extraction of keywords may not be performed during which a viewer watches a program in another genre such as drama. In this case, the genre of a program acquired from EPG and the genre for which keyword extraction is previously set by a user are compared with each other. When both genres are matched, keywords are extracted. Otherwise, the keywords are not extracted. The setting condition acquirement unit 212 acquires settings set by a user and transfers the user settings to the search instruction unit 208 so as to instruct the search instruction unit 208 to search for keywords according to the user settings, if necessary.

When the keyword search is not set for the currently viewed program, if the user settings are set to indicate a past keyword extraction result, a result of extracting keywords previously performed is displayed on the display panel 124. For example, when the genre of the currently viewed program is drama and it is set that keywords are not extracted for that genre and the past keyword extraction result is displayed instead, a result of extracting keywords previously performed in the past for the sports program may be displayed as illustrated in FIG. 3.

Also, the extraction of keywords may always be performed when the ES of the subtitle data exists in a broadcast signal. The extraction of keywords is possible because the text of the subtitle data may be interpreted regardless of turning on/off of displaying the subtitle data on the display panel 124.

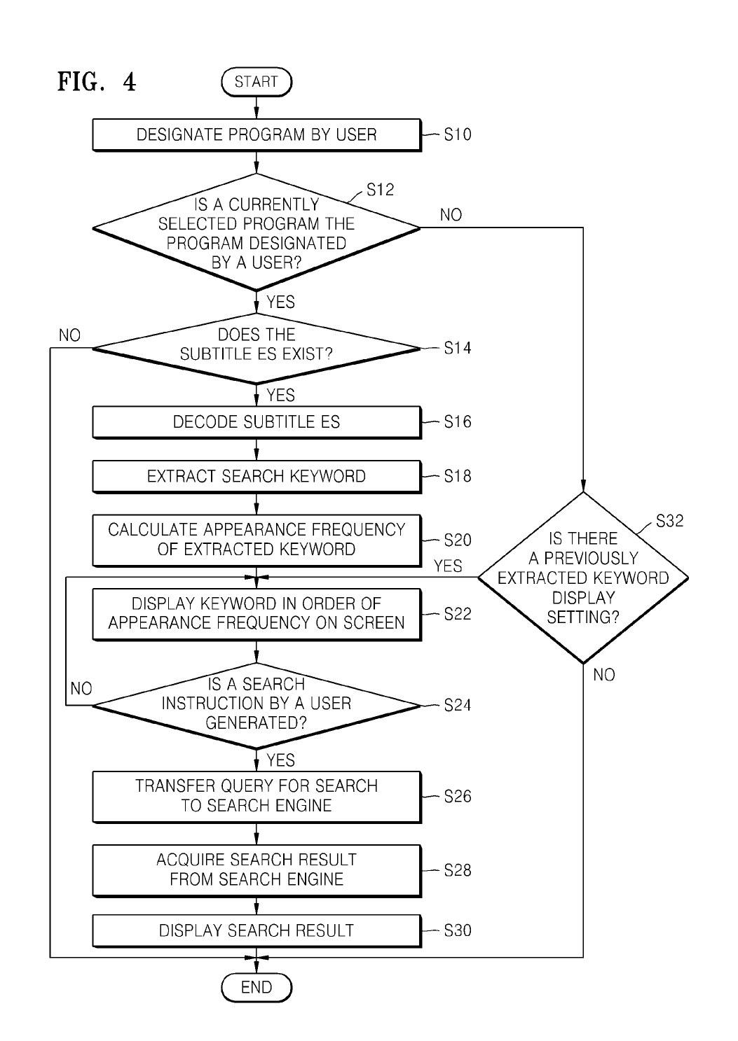

Next, the process sequence in the digital broadcasting receiver 100 according to the present exemplary embodiment will be described based on FIG. 4. First, a program to extract keywords is designated by a user (S10). A program may be directly designated according to the EPG information or the genre of the program, for example, drams, sports, movie, or news. In addition, when the user's designation is stored in a memory, there is no need to perform the operation S10 whenever turning the power on.

Next, it is determined whether a currently selected program is the program designated in the operation S10 (S12). If the currently selected program is the designated program, the program goes to the next operation.

It is determined whether the ES of a subtitle exists in a broadcast signal (S14). When the subtitle ES exists, the program goes to the next operation S16 so that subtitle data is decoded from the subtitle ES. Next, a search keyword is extracted from the decoded subtitle data (S₁₈). For example, words that are nouns are extracted from the subtitle data.

Next, the frequency of appearance is calculated for each of the extracted keywords (S20). The frequency of extractions of each keyword is calculated within a particular time period. The keywords extracted in order of the frequency of appearance calculated in the operation S20 are displayed on the display panel 124.

It is determined whether a search instruction is generated for any of the displayed keywords by a user using a remote controller (S24). When the search instruction is generated, the program goes to the next operation S26 to transfer a search instruction query to a search engine through the Internet 150.

A result of search is acquired from the search engine (S28). The search result is displayed on a screen of the display panel 124 (S30). The program is terminated after the operation S30.

In the operation S12, when the currently selected program is not the designated program, the program goes to the operation S32. In the operation S32, it is determined whether displaying of the keywords extracted previously is set. When the keywords extracted previously are set to be displayed, the program goes to the operation S22 in which the keywords extracted previously are displayed in order of the frequency of appearance. When the displaying of the keywords extracted previously is not set, the program is terminated.

As described above, since the keywords extracted from the subtitle data may be displayed on the display panel 124 and searched by a search engine, the convergence of the broadcasting receiving function of terrestrial digital waves and the search function through the Internet 150 is possible so that information may be further acquired from the search engine regarding the broadcasted information. Thus, while watching a program, a user may efficiently search for information related to the program in real time by using the search engine.

While particularly shown and described with reference to exemplary embodiments thereof, it will be understood by those skilled in the art that various changes in form and details may be made therein without departing from the spirit and scope of the invention as defined by the appended claims.

The exemplary embodiments can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. In other exemplary embodiments, the computer readable recording medium can also be distributed over network coupled computer systems so that the computer readable code is stored and executed in a distributed fashion.

What is claimed is:

1. A method of searching a keyword, the method comprising:
extracting a keyword from subtitle data included in a broadcast signal;
displaying the extracted keyword with an image according to the broadcast signal;
searching by an search engine, using the displayed keyword when an instruction to search using the displayed keyword is received through a communication network; and
displaying a search result of the search engine.

2. The method of claim 1, wherein, in the extracting of the keyword, the keyword is extracted by a program designated according to electronic program guide (EPG) information or genre of the program.

3. The method of claim 1, wherein the extracting of the keyword comprises:
determining whether a subtitle element stream exists in the broadcast signal;
decoding subtitle data from the subtitle element stream; and
extracting the keyword from the subtitle data.

4. A method of searching a keyword, the method comprising:
determining whether to extract the keyword according to user settings;
extracting a keyword from subtitle data included in a broadcast signal, if the keyword is to be extracted;
displaying the extracted keyword with an image according to the broadcast signal;
searching by an search engine, using the displayed keyword when an instruction to search using the displayed keyword is received through a communication network; and
displaying a search result of the search engine.

5. The method of claim 4, wherein, in the determining of whether to extract the keyword, a program acquired from the EPG is compared with the user settings and, when the program and the user settings are matched to each other, the keyword is extracted and, if not, the keyword is not extracted.

6. The method of claim 1, further comprising:
calculating a frequency of appearance of the extracted keyword;
determining an order of the extracted keyword and another extracted keyword based on the frequency of appearance of the extracted keyword and a frequency of appearance of the other extracted keyword; and
displaying information about the frequencies of appearance.

7. The method of claim 1, further comprising displaying a result of keyword extraction previously performed, on a screen, when keyword search is not set for a currently viewed program.

8. A broadcasting receiver comprising:
a signal processing unit which acquires subtitle data from a broadcast signal;
a keyword extraction unit which is operable to extract a keyword from the subtitle data;
a keyword display instruction unit which displays the extracted keyword with an image according to the broadcast signal;
a search instruction unit instructs for transferring the displayed keyword to a search engine through a communication network when a search instruction is received with respect to the displayed keyword; and
a search result display unit which displays a search result of the search engine.

9. The broadcasting receiver of claim 8, further comprising an appearance frequency calculation unit which calculates a frequency of appearance of the keyword extracted by the keyword extraction unit, wherein the keyword display instruction unit displays a plurality of keywords including the extracted keyword, in an order of the corresponding frequencies of appearance.

10. The broadcasting receiver of claim 8, wherein the keyword extraction unit extracts the keyword only when a program designated by a user is received.

11. The broadcasting receiver of claim 8, wherein the keyword extraction unit compares a predetermined program with user settings and, extracts the keyword when the predetermined program and the user settings are matched to each other, and does not extract the keyword when the predetermined program and the user settings are not matched to each other.

12. The broadcasting receiver of claim 8, further comprising a setting condition acquirement unit which acquires user settings and transfers the user settings to the search instruction unit.

13. A broadcasting receiver comprising:
a signal processing unit which acquires subtitle data from a broadcast signal;
a central processing unit which extracts a keyword from the subtitle data acquired by the signal processing unit, and instructs for a keyword search of the extracted keyword by using a search engine, through a communication network, when a search instruction is received with respect to the extracted keyword; and
a display control unit which controls a displaying of the keyword extracted by the central processing unit and a result of the keyword search, on a display panel.

14. The broadcasting receiving of claim 13, further comprising a memory which stores a user designated program for the keyword extraction of the central processing unit.

15. A method of searching comprising:
extracting a plurality of text from subtitle data of a broadcast signal;
determining frequencies of appearance of the plurality of text;
displaying the extracted plurality of text according to the determined frequencies of appearance;
receiving user input regarding a user selection of one of the displayed plurality of text;
transferring the selected one of the plurality of text to a search engine;
receiving a search result from the search engine; and
displaying the search result.
